(19) United States
(12) Patent Application Publication
(10) Pub. No.: US 2021/0058361 A1
(43) Pub. Date: Feb. 25, 2021

(54) SYSTEM AND METHOD FOR COLLECTING AND STORING ELECTRONIC MESSAGES OF DIFFERENT TYPES BASED ON SUBJECT MATTER

(71) Applicant: MESH01, LLC, Portsmouth, NH (US)

(72) Inventors: Lane Belling, St. Anthony, MN (US); Brian James Bednarek, Rye, NH (US); Richard Pressler, Quincy, MA (US)

(21) Appl. No.: 16/941,966

(22) Filed: Jul. 29, 2020

Related U.S. Application Data
(63) Continuation-in-part of application No. 15/970,936, filed on May 4, 2018, now Pat. No. 10,749,820.

(51) Int. Cl. H04L 12/58

(52) U.S. Cl. CPC H04L 51/36

(57) ABSTRACT

A method for receiving, integrating and storing messages received from and sent to various users in different message types by subject matter. Individual users can communicate with the system via a preferred message type of each individual user. Each user message includes a subject matter. The system and method store each sent and received message to and from each user by subject matter thus allowing all messages relating to a particular subject matter to be queried and reported irrespective of the message type in which they are sent and/or received.

### CROSS-REFERENCE TO RELATED APPLICATIONS

This application is a continuation-in-part of U.S. patent application Ser. No. 15/970,936 filed May 4, 2018 titled Message Integrator, which application is fully incorporated herein by reference.

### FIELD OF THE INVENTION

NOM The present application relates to the integration of electronic messages received from various users in various formats and across various platforms into a single platform all wherein all electronic messages related to the same topic are linked to and associated with that topic.

### BACKGROUND

Electronic communications dominate in the business world. People in cubicles sitting next to each other will often use communication channels such as email or instant messaging rather than actually talking to one another. As bizarre as this behavior might seem, it serves a useful purpose because it provides a searchable record of the communications.

While it might seem bizarre to use these communication channels in an office, with people in your immediate vicinity, it becomes essential when you are working with remotely-located staff. This is especially true when you are dealing with independent contractors, who may each have his or her preferred method of electronic communication.

With so many varied means of communication, the problem becomes one of integrating all these into a single searchable database. While emails typically have a subject line that can be used to link messages, other communications such as text messages do not have subject lines; and it becomes virtually impossible to integrate the multiple message channels into a single database and tie it to a specific subject.

Therefore, there continues to be a need for a way of integrating messages from a diverse set of platforms without requiring the user of the database to specify the subject.

### SUMMARY OF THE INVENTION

In order to overcome the deficiencies in the prior art, systems and methods are described herein.

One aspect of the claimed invention involves methods for integrating communications data comprising for at least a first and a second communication channel into a database by project wherein the first communication channel is configured to send communication data directly to the database and the second communication is periodically pooled in order to initiate data transfer to the database.

The method further comprises initiating a project within a system, associated with an Analyst, by sending a project initiation message on at least the first and second communication channel to at least a first and second Tester, wherein everyone has a separate communication address on each of the first and second communication channels; transmitting a copy of all the communication on the first communication channel between the Analyst and either of the at least first or second Testers directly to the database and linking all of these communications with the first project; periodically pooling the second communication channel for messages between the Analyst and either of the at least first or second Testers and linking all of these communications with the first project and storing the desired data from these messages in the database; combining all of the linked communication data into a message for the Analyst; querying message stream; and generating reports

A further aspect involves the Analyst initiating a second project within the system, by sending a second project initiation message on the at least the first and second communication channel to the first Tester and at least a third Tester; transmitting a copy of all new communication on the first communication channel between the first Analyst and either of the first Tester or the at least third Tester directly to the database and linking all of these communications with the second project; periodically pooling the second communication channel for new messages between the first Analyst and either of the first or the at least third Tester and linking all of these communications with the second project and storing the desired data from these messages in the database; combining all of the linked communication data into a message for the Analyst; querying the message stream for data by either first or second project; and generating a report based upon the data.

An additional further aspect involves having a second Analyst initiating a third project within the system, by sending third project initiation message on the at least the first and second communication channel to the at least first Tester and second Tester; transmitting a copy of all new communication on the first communication channel between the second Analyst and either of the at least first Tester or second Tester directly to the database and linking all of these communications with the third project; periodically pooling the second communication channel for new messages between the second Analyst and either of the at least first Tester or second Testers and linking all of these communications with the third project and storing the desired data from these messages in the database; combining all of the third projects linked communication data into a second message stream viewable by the second Analyst; querying the second Analyst message stream; and generating a report based upon the data.

In another embodiment, the invention features a method for collecting and storing electronic communication data of differing electronic message types by a communication system. The method comprises the acts of registering a first communication system user by the communication system. The act of registering the first communication system user itself comprises receiving a first electronic message from the first communication system user, the first electronic message of a first predetermined type. The first electronic message from the first communication system user including a preferred electronic message type that the first communication system user desires to utilize for communication to and from the communication system. The first electronic message also including a subject matter of the first electronic message. The method also includes storing the first electronic message by the communication system according to the subject matter of the received first electronic message.

The method also registers at least a second communication system user by the communication system, the act the registering the second communication system user comprising receiving a first electronic message from the at least a second communication system user, the first electronic message received from the at least a second communication system user of the first predetermined type, the first electronic message from the at least a second system communication user including a preferred electronic message type that the at least a second communication system user desires to utilize for communication to and from the communication system. The first electronic message from the at least a second communication system user also includes a subject matter of the first electronic message from the at least a second communication system user. The preferred electronic message type received from the at least a second communication system user is different from the preferred electronic message type received from the first communication system user.

The method stores the first electronic message received from the at least a second communication system user by the communication system according to the subject matter of the first electronic message. The method sends, as required, an electronic message from the communication system to the first communication system user utilizing the preferred electronic message type received from the first communication system user and including a subject matter of the electronic message while also sending, as required, an electronic message from the communication system to the at least a second communication system user utilizing the preferred electronic message type received from the at least a second communication system user and including a subject matter of the electronic message.

The method includes receiving an electronic message by the communication system from the first communication system user utilizing the first communication system user preferred electronic message type, the received electronic message including a subject matter of the electronic message and storing the received electronic message by the communication system according to the subject matter of the received electronic message and receiving an electronic message by the communication system from the at least a second communication system user utilizing the at least a second communication system user preferred electronic message type, the received electronic message including a subject matter of the electronic message.

The method controls the storing of the electronic message by the communication system according to the subject matter of the received electronic message. The communication system is configured for displaying, to a display device, all received electronic messages from all communication system users in all electronic message types according to the subject matter of the received electronic messages.

The electronic message types are selected from the group of electronic message types comprising Email, SMS text, Instant Messenger (IM), Instagram, WhatsApp, Twitter, and TikTok.

These and other aspects described herein present in the claims result in features and/or can provide advantages over current technology. [0017] The advantages and features described herein are a few of the many advantages and features available from representative embodiments and are presented only to assist in understanding the invention. It should be understood that they are not to be considered limitations on the invention as defined by the claims, or limitations on equivalents to the claims. For instance, some of these advantages or features are mutually exclusive or contradictory, in that they cannot be simultaneously present in a single embodiment. Similarly, some advantages are applicable to one aspect of the invention, and inapplicable to others. Thus, the elaborated features and advantages should not be considered dispositive in determining equivalence. Additional features and advantages of the invention will become apparent in the following description, from the drawings, and from the claims.

### BRIEF DESCRIPTION OF THE DRAWINGS

These and other features and advantages of the present invention will be better understood by reading the following detailed description, taken together with the drawings wherein:

FIG. 1 shows, in simplified form, a representative system architecture;

FIG. 2 shows, in simplified form, a representative method for integrating messaging; and

FIGS. 3A and 3B illustrate a method for integrating messaging according to another embodiment of the present invention.

### DETAILED DESCRIPTION OF THE PREFERRED EMBODIMENT

The instant devices and approach provide a way of integrating at least a first and a second communication channel (first and second message types) into a database by project, without the user needing to specify the subject. In one embodiment, the first communication channel is configured to send communication data directly to the database, and the second communication channel is periodically pooled in order to initiate data transfer to the database. In another embodiment, the first communication channel refers to a message of a first communication type (i.e. for example one of communication types including but not limited to Email, SMS text, Instant Messenger (IM), Instagram, WhatsApp, Twitter, and TikTok) while the second communication channel refers to a message of a second communications type, different from the first communications type, also including but not limited to Email, SMS text, Instant Messenger (IM), Instagram, WhatsApp, Twitter, and TikTok.

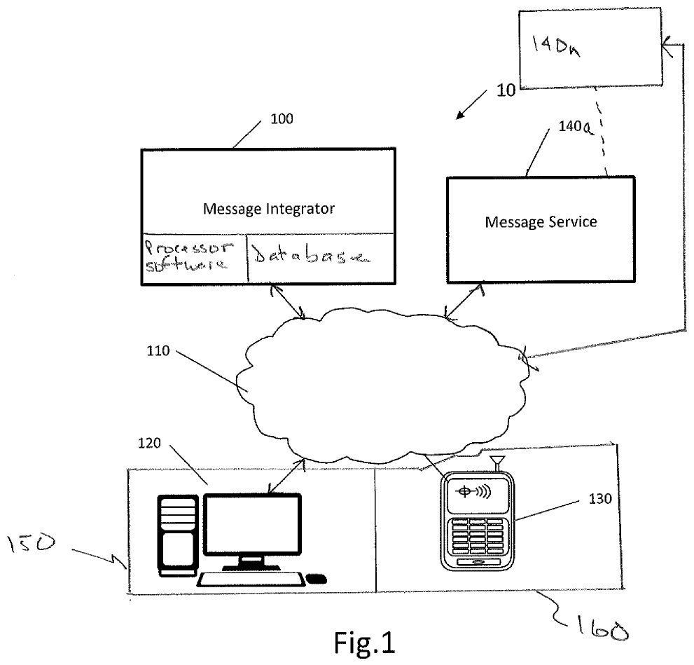

FIG. 1 shows, in simplified form, a representative system architecture 10. The system architecture 10 comprises a message integrator 100, according to the present invention, connected to cloud 110. Also connected to the cloud 100 are one or more message services 140a-140n and at least two user interfaces 120, 130.

The message integrator 100 comprises one or more processors, configured to run computer code; computer code; and one or more databases configured to store information. The message integrator 100 is configured to exchange information, including messages, via cloud 110, with the one or more message services 140a-140n such as an email message service, SMS text message service; Instant messenger service or the like, and the two or more user interfaces 120, 130, as well as to store and process data and to produce reports.

One user interface 120 is associated with a system analyst 150 (an individual associated with a company that wants to initiate product testing or consumer survey or the like) and a user or “tester” 160 (in the present example: an individual who agrees to try or “test” a product being offered by or contemplated to be offered by a company or business or also potentially a survey responder.) At least one of the user interfaces 120 is for the exchange of information to and from an analyst 150 and the other user interface 130 is for the exchange of information to and from a tester 160. The user interfaces 120, 130 may include a computer, smart phone, tablet or any other similar device that can send and receive electronic messages via the World Wide Web.

In one embodiment, messages can be exchanged directly from the message integrator 100 to one or more of the Analysts 150 or Testers 160 using the one or more interfaces 120, 130 via the cloud 110. Examples of such representative messages include but are not limited to SMS, email, voicemail, video messages, Tweets®, and instant messaging.

In another embodiment and more typically, messages can be exchanged between the Analyst 150 and Tester 160 using the one or more interfaces 120, 130, via the cloud 110, using the one or more messaging services 140a-140n. Examples of representative messaging services include, but are not limited to, SMS, email, voicemail, video messages, Tweets®, and instant messaging services.

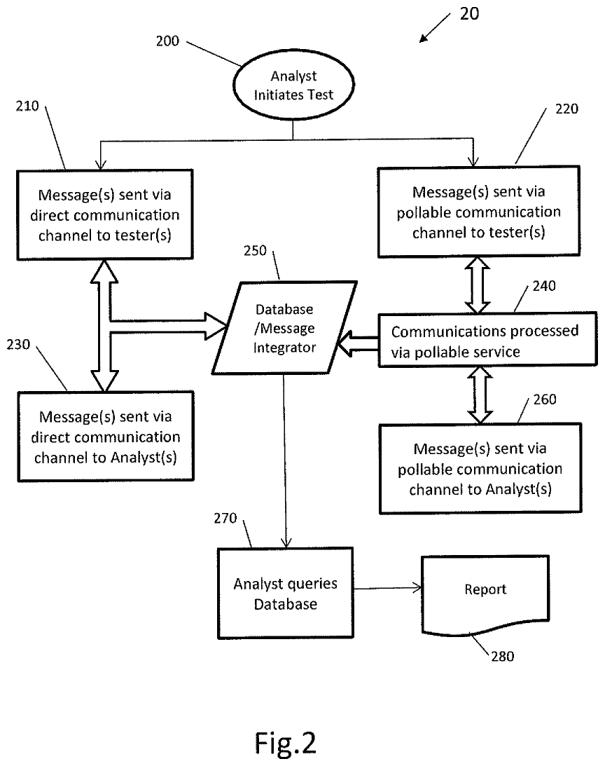

FIG. 2 shows, in simplified form, a representative method 20 for integrating messaging.

The method 20 begins with an Analyst initiating a test or survey [Step 200].

Once the test has been initiated, messages are exchanged between Analyst(s) (and/or the system) and Tester(s) follow one of two paths:
1) using direct communication channels: messages are sent via one or more direct communication channel(s) to the Tester(s) [Step 210] and messages are sent via one or more direct communication channel(s) to the Analyst(s) [Step 230] or
2) using pollable communication channels: messages are sent via one or more pollable communication channel(s) to the Tester(s) [Step 220] and messages are sent via one or more pollable communication channel(s) to the Analyst(s) [Step 260], after the communications are processed through a pollable communication service [Step 210].

A pollable communication service is one that the communications data related to messaging exchanged within it is available via API or other means. For example, you can use Twitter's® API to find out all the public messages sent to and from a particular address. However, you need one of the individual's user information to access messages exchanged privately.

Similarly, you typically need the Analyst's (or Tester's) email account information to log in to the email exchange to pull email correspondence between an Analyst and Tester. Another example is voicemail where you typically a passcode to access an Analyst's (or Tester's) voicemail. Voicemail (or video messages) is interesting because it is a system where who the call is from may or may not be available. In such a case, a secondary process such as voice recognition (or image recognition) or even voice to text conversion can be used to determine who is speaking. The polling frequency can be occur at a fixed frequency, vary with time, or be individualized based on communication channel or even by Analysist.

It should be noted that the messages sent via direct communication channel(s) to Tester(s) [Step 210] and/or messages are sent via pollable communication channel(s) to Tester(s) [Step 220] can either be messages sent from either an Analyst or can be system messages. All of the parties: each Analyst, system, and each Tester must have a separate communication address on each communication channel, although they can have the same address on multiple channels. For instance, a phone number can be used for both SMS as well as voice messaging; however, the phone number is used uniquely for each communication channel. Additionally, many services allow the spoofing of messages, where the message that initiates from one address appears as if it came from another address. As such, messages can, for example, be initiated from the system that appear as if they are communications directly from the Analyst.

Examples of system messages include, but are not limited to: test initiation, test termination messages, survey available, survey completed, data missing, reports, parametric data from wearables, video and voice messages.

The types of messages include, but are not limited to: SMS, email, voicemail, video messages, Tweets®, and instant messaging services.

Messages sent via direct messaging [Step 210], [Step 230] will be stored within the database/message integrator 250 automatically and linked to the most recent test that a particular Analyst started with a particular Tester.

For example, if a First Analyst initiates a First Test with at least a first and second Tester . . . . All of the messages communicated while the First Test is still open, between the First Analyst and either of the at least a first subject and second Tester, will be stored within the database/message integrator 250 and linked to the First Test.

If at a later time, the First Analyst initiates a Second Test, with the first Tester and at least a third Tester, then all new communication to the first Tester, as well as the third Tester, will be linked to the Second Test. However, as long as the First Test hasn't been closed, the communication between the Analyst and the second Tester can, depending on system settings, be stored and linked to the First Test, disregarded or processed as an error.

On the other hand, if at a later time, a Second Analyst initiates a Third Test with at least the first and second Tester, then all communication between the first Tester, as well as the third Tester, will be linked to the second test. All of the messages communicated while the Third Test is still open, between the Second Analyst and either of the at least a first subject and second Tester, will be stored within the database/message integrator 250 and linked to the Third Test.

The role of the database/message integrator 250 is to combine all of the messages into a single communication channel for example, instant messaging, which may/or may not be one of the communication channels used to communicate with one or more of the Testers.

Instant messaging is one of the simplest but highly effective forms of communication. It includes, date/time of the message, who the message was to/from and the message, which can often include attachments. It does not include things like a subject line, and fields like CC and BCC.

With respect to additional fields, the database/message integrator 250 can take one or more of the following representative actions: ignore/discard them; store them as additional data, available to the user as an attachment or the click of a button; inserted the data into the message (for example the subject line being inserted into the message as the first line of text), transpose the information (for example voice to text transcription; or do a combination of the above. The importance being not the particular action taken but that the information the analysts need (or typically needs) is available to them. The actions taken can be the same for all Analysts or individualized settings for one or more Analysts.

The final step is the Analyst queries the database [Step 270] and produces a report 280. The types of reports produce can include but are not limited to which messages contain (or exclude) a particular phrase, which messages came through on a particular communication channel, which Testers have not received a particular system message (e.g. survey completed or data missing messages), who communicated (or didn't communicate) over a certain period of time. The importance being not the particular type of query/report but that the information the analyst needs (or typically needs) is available to them. The type of queries/reports available can be the same for all Analysts or individualized based upon settings for one or more Analysts.

Throughout this document the generic terms: Analysts, Test and Tester have been used. While, the system can be used for an Analysts that wants to have Testers in the field perform and provide feedback related to a specific test (e.g. garment fit, comfort of durability testing), the terms should be thought of more generally as well. Other examples include but are not limited to soliciting feedback from patients related to medical devices/prescriptions and law enforcement tip lines, where data comes from citizens or surveys.

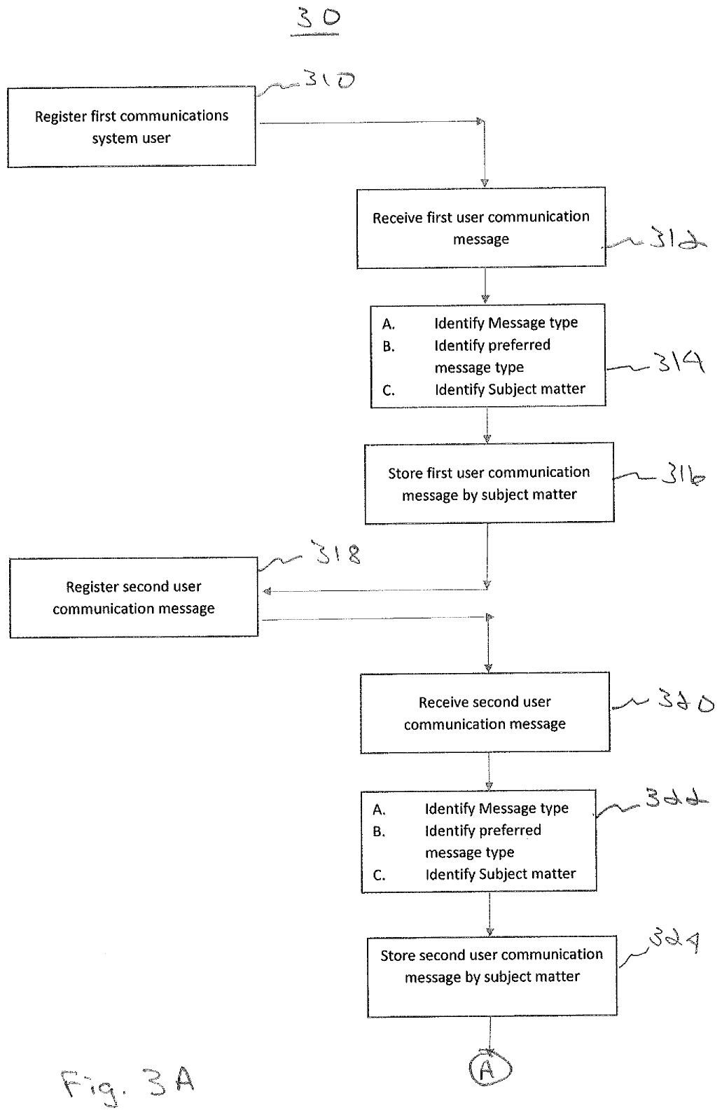

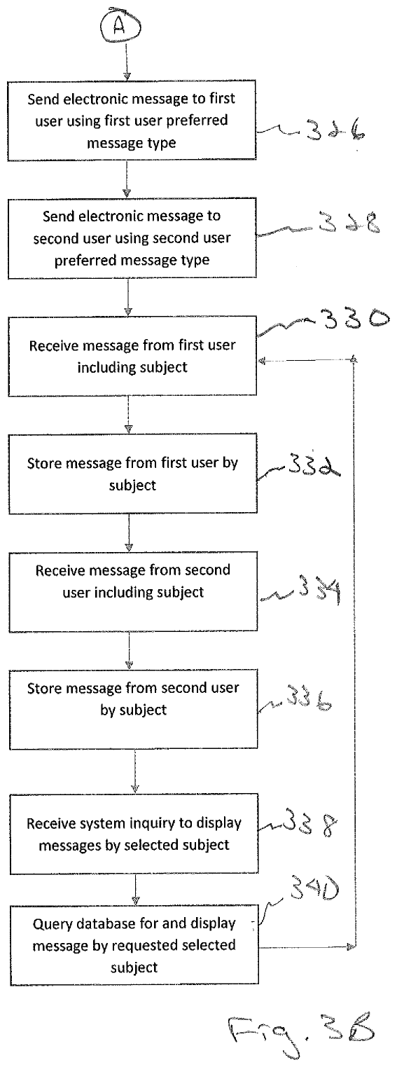

In another embodiment shown and described in connection with FIG. 3, the method 30 for collecting and storing electronic communication data of differing electronic message types by a communication system begins with an analyst initiating a test or survey. Once the test has been initiated, messages are exchanged between the analyst(s) (and/or the system) and one or more testers or “users”.

The method then continues by registering a first communication system user by the communication system, act 310, by receiving a first electronic message from the first communication system user 312. The first electronic message is of a first predetermined type and includes a preferred electronic message type that the first communication system user desires to utilize for communication to and from the communication system. The first electronic message also includes a subject matter of the first electronic message. The system identifies the message type, identifies the user's preferred message communications type and identifies the subject matter of the message, act 314. The system then stores the message, act 316, according to the subject matter of the first electronic message received from the first user.

The method then continues by registering at least a second communication system user, act 318, which act includes receiving an electronic message from a second and subsequent user of the communication system, act 320, and registering the second and subsequent communication system user, act 322, after identifying a preferred electronic message type that the second and each subsequent communication system user desires to utilize for communication to and from the communication system. The preferred electronic message type of the second and each subsequent communication system user may or may not be different from the preferred electronic message type received from the first communication system user. Each message received from the second and each subsequent communication system user also includes a subject matter.

The method next stores each electronic message received from the second and subsequent communication system users according to the subject matter of the electronic message, act 324.

Next, an electronic message is sent from the communication system (typically initiated by an analyst) to the first communication system user utilizing the preferred electronic message type received from the first communication system user and including a subject matter of the electronic message, act 326. An electronic message is at some point also sent from the communication system/analyst to the second and/or subsequent communication system user utilizing the preferred electronic message type received from the second and subsequent communication system user, including a subject matter of the electronic message, act 328.

After receiving an electronic message by the communication system from the first communication system user utilizing the first communication system user preferred electronic message type and including a subject matter of the electronic message, act 330, the method stores the received electronic message according to the subject matter of the received electronic message, act 332.

The method awaits receipt of an electronic message from the second and subsequent communication system users, act 334, utilizing the at least a second communication system user preferred electronic message type and including a subject matter of the electronic message, followed by storing the electronic message by the communication system according to the subject matter of the received electronic message, act 338.

Upon a query by an analyst or other authorized system user, the communication system is configured for displaying a report, to a display device such as a monitor, display devise or printer, all received electronic messages from all communication system users in all electronic message types according to the subject matter of the received electronic messages act 340.

The types of reports produced can include but are not limited to which messages contain (or exclude) a particular phrase, which messages came through on a particular communication channel, which testers have not received a particular system message (e.g. survey completed or data missing messages), who communicated (or didn't communicate) over a certain period of time. The importance being not the particular type of query/report but that the information the analyst needs (or typically needs) is available to them by subject matter, irrespective of the communication message type used between the tester and the system. The type of queries/reports available can be the same for all analysts or individualized based upon settings for one or more Analysts

Finally, it is to be understood that various different variants of the invention, including representative embodiments and extensions have been presented to assist in understanding the invention. It should be understood that such implementations are not to be considered limitations on either the invention or equivalents, except to the extent they are expressly in the claims. It should therefore be understood that, for the convenience of the reader, the above description has only focused on a representative sample of all possible embodiments, a sample that teaches the principles of the invention.

The description has not attempted to exhaustively enumerate all possible permutations, combinations or variations of the invention, since others will necessarily arise out of combining aspects of different variants described herein to form new variants, through the use of particular hardware or software, or through specific types of applications in which the invention can be used. That alternate embodiments may not have been presented for a specific portion of the description, or that further undescribed alternate or variant embodiments may be available for a portion of the invention, is not to be considered a disclaimer of those alternate or variant embodiments to the extent they also incorporate the minimum essential aspects of the invention, as claimed in the appended claims, or an equivalent thereof.

What is claimed is:

1. A method for collecting and storing electronic communication data of differing electronic message types by a communication system, said method comprising the acts of:
registering a first communication system user by said communication system, said act of registering said first communication system user comprising:
receiving a first electronic message from said first communication system user, said first electronic message of a first predetermined type, said first electronic message from said first communication system user including a preferred electronic message type that said first communication system user desires to utilize for communication to and from said communication system, said first electronic message and also including a subject matter of said first electronic message; and
storing said first electronic message by said communication system according to said subject matter of said received first electronic message;
registering at least a second communication system user by said communication system, said act the registering said second communication system user comprising:
receiving a first electronic message from said at least a second communication system user, said first electronic message received from said at least a second communication system user of said first predetermined type, said first electronic message from said at least a second system communication user including a preferred electronic message type that said at least a second communication system user desires to utilize for communication to and from said communication system, said first electronic message also including a subject matter of said first electronic message, wherein said preferred electronic message type received from said at least a second communication system user is different from said preferred electronic message type received from said first communication system user; and
storing said first electronic message received from said at least a second communication system user by said communication system according to said subject matter of said first electronic message;
sending an electronic message from said communication system to said first communication system user utilizing said preferred electronic message type received from said first communication system user and including a subject matter of said electronic message;
sending an electronic message from said communication system to said at least a second communication system user utilizing said preferred electronic message type received from said at least a second communication system user and including a subject matter of said electronic message;
receiving an electronic message by said communication system from said first communication system user utilizing said first communication system user preferred electronic message type, said received electronic message including a subject matter of said electronic message;
storing said received electronic message by said communication system according to said subject matter of said received electronic message;
receiving an electronic message by said communication system from said at least a second communication system user utilizing said at least a second communication system user preferred electronic message type, said received electronic message including a subject matter of said electronic message;
storing said electronic message by said communication system according to said subject matter of said received electronic message; and
wherein said communication system is configured for displaying, to a display device, all received electronic messages from all communication system users in all electronic message types according to said subject matter of said received electronic messages.

2. The method of claim 1, wherein said electronic message of a first predetermined type is email.

3. The method of claim 1, wherein said electronic message types are selected from the group of electronic message types comprising Email, SMS text, Instant Messenger (IM), Instagram, WhatsApp, Twitter, and TikTok.
